(19) United States
(12) Patent Application Publication
(10) Pub. No.: US 2026/0287212 A1
(43) Pub. Date: Sep. 24, 2026

(54) NON-CONDENSABLE GAS REINJECTION SYSTEM

(71) Applicant: FUJI ELECTRIC CO., LTD., Kanagawa (JP)

(72) Inventors: Hirono OKANO, Tokyo (JP); Shinya UI, Tokyo (JP)

(21) Appl. No.: 19/632,902

(22) Filed: Mar. 30, 2026

Related U.S. Application Data
(63) Continuation of application No. PCT/JP2025/028017, filed on Aug. 6, 2025.

(30) Foreign Application Priority Data
Feb. 6, 2025 (JP) 2025-018086

(51) Int. Cl. F24T 10/20; F03B 13/00; F22B 1/16; F24T 10/00; G05D 7/06; G05D 9/12

(52) U.S. Cl. CPC F24T 10/20; F03B 13/00; G05D 7/0635; G05D 9/12; F22B 1/16; F24T 2010/56

(57) ABSTRACT

A non-condensable gas reinjection system is provided for use in a geothermal power plant including a gas-liquid separator configured to separate geothermal fluid obtained from a production well into a first gas and a first liquid, an evaporator configured to exchange heat between the first gas and a working fluid, a turbine configured to be rotated by the working fluid discharged from the evaporator, and a condenser configured to cool the working fluid that has rotated the turbine and to condense the working fluid into a liquid. The non-condensable gas reinjection system includes: a pump configured to pressurize a third liquid to be sent to a reinjection well; and an ejector configured to be driven by the third liquid, suction a non-condensable gas contained in the first gas and remaining uncondensed in the evaporator, and discharge a fourth liquid in which the third liquid and the non-condensable gas are mixed.

### CROSS-REFERENCE TO RELATED APPLICATIONS

This application is a continuation of International Application No. PCT/JP2025/028017, filed on Aug. 6, 2025 and designating the U.S., which claims priority to Japanese Patent Application No. 2025-018086, filed on Feb. 6, 2025. The contents of these applications are incorporated herein by reference in their entirety.

### TECHNICAL FIELD

The present disclosure relates to a non-condensable gas reinjection system.

### BACKGROUND ART

Patent Document 1 discloses a method of disposing of a non-condensable gas generated in a geothermal power generation facility, in which a non-condensable gas generated in a condenser provided downstream of a steam turbine is injected into a reinjection well for hot water reinjection so as to be reinjected underground together with reinjection hot water.

Patent Document 2 discloses a geothermal power generation plant including a reinjection water flow passage configured to convey reinjection water to a reinjection well, a gas removal system configured to extract a gas from a condenser, and a gas flow passage configured to supply the gas extracted from the condenser to the reinjection water flow passage and mix the gas into the reinjection water.

### RELATED-ART DOCUMENTS

### Patent Documents

Patent Document 1: Japanese Laid-Open Patent Publication No. H 9-177507

Patent Document 2: Japanese Laid-Open Patent Publication No. 2018-017188

### SUMMARY OF THE INVENTION

The present disclosure provides a non-condensable gas reinjection system for use in a geothermal power plant including a gas-liquid separator configured to separate geothermal fluid obtained from a production well into a first gas and a first liquid, an evaporator configured to exchange heat between the first gas and a working fluid, a turbine configured to be rotated by the working fluid discharged from the evaporator, and a condenser configured to cool the working fluid that has rotated the turbine and to condense the working fluid into a liquid. The non-condensable gas reinjection system includes: a pump configured to pressurize a third liquid to be sent to a reinjection well; and an ejector configured to be driven by the third liquid, to suction a non-condensable gas contained in the first gas and remaining uncondensed in the evaporator, and to discharge a fourth liquid in which the third liquid and the non-condensable gas are mixed. The first liquid and the fourth liquid are mixed and sent to the reinjection well.

### BRIEF DESCRIPTION OF THE DRAWINGS

FIG. 1 is a diagram schematically illustrating a configuration of a geothermal power plant including a non-condensable gas reinjection system according to a first embodiment;

FIG. 2 is a diagram schematically illustrating a configuration of an ejector of the non-condensable gas reinjection system according to the first embodiment;

FIG. 3 is a diagram schematically illustrating a configuration of a geothermal power plant including a non-condensable gas reinjection system according to a second embodiment;

FIG. 4 is a diagram schematically illustrating a configuration of a geothermal power plant including a non-condensable gas reinjection system according to a third embodiment;

FIG. 5 is a diagram schematically illustrating a configuration of a geothermal power plant including a non-condensable gas reinjection system according to a fourth embodiment;

FIG. 6 is a diagram illustrating a determination as to whether a non-condensable gas is dissolved in a non-condensable gas reinjection system according to an embodiment of the present disclosure;

FIGS. 7A and 7B are diagrams illustrating the determination as to whether the non-condensable gas is dissolved in the non-condensable gas reinjection system according to the embodiment of the present disclosure;

FIG. 8 is a diagram illustrating a first example of processing in a case where the non-condensable gas is not dissolved in the non-condensable gas reinjection system according to the embodiment of the present disclosure;

FIG. 9 is a diagram illustrating a second example of processing in a case where the non-condensable gas is not dissolved in the non-condensable gas reinjection system according to the embodiment of the present disclosure;

FIG. 10 is a diagram illustrating a third example of processing in a case where the non-condensable gas is not dissolved in the non-condensable gas reinjection system according to the embodiment of the present disclosure; and

FIG. 11 is a diagram schematically illustrating a configuration of a geothermal power plant including a non-condensable gas reinjection system according to a fifth embodiment.

### DESCRIPTION OF THE EMBODIMENTS

In geothermal power generation, in a case where a non-condensable gas such as carbon dioxide or hydrogen sulfide is included, the gas accumulates in an upper portion of an evaporator and the liquid contact area in the evaporator decreases, thereby resulting in a decrease in heat exchange efficiency. In order to prevent a decrease in heat exchange efficiency, the non-condensable gas is removed by an extraction passage or an extractor using the pressure of the non-condensable gas itself. For example, the non-condensable gas is sent from the evaporator to a cooling tower, mixed with air, and released into the atmosphere.

The present disclosure provides a non-condensable gas reinjection system that returns a non-condensable gas contained in geothermal fluid to a reinjection well and has high maintainability.

Embodiments will be described below with reference to the accompanying drawings. Note that the present disclosure is not limited to these examples, and is intended to be indicated by the claims and to include all modifications within the meaning and scope equivalent to the scope of the claims.

Note that, in the specification and the drawings of the embodiments, components having substantially the same or corresponding functional configurations are denoted by the same reference numerals, and redundant descriptions thereof may be omitted. For ease of understanding, the scale of each part in the drawings may be different from the actual scale.

### First Embodiment

A non-condensable gas reinjection system according to a first embodiment will be described. The non-condensable gas reinjection system according to the first embodiment is used in a geothermal power plant. The geothermal power plant using the non-condensable gas reinjection system according to the first embodiment includes a gas-liquid separator configured to separate geothermal fluid obtained from a production well into a first gas and a first liquid, and an evaporator configured to exchange heat between the first gas and a working fluid. Further, the geothermal power plant using the non-condensable gas reinjection system according to the first embodiment includes a turbine configured to be rotated by the working fluid discharged from the evaporator, and a condenser configured to cool the working fluid that has rotated the turbine, and to condense the working fluid into a liquid. The non-condensable gas reinjection system according to the first embodiment includes a pump configured to pressurize a third liquid to be sent to a reinjection well, and an ejector. The ejector of the non-condensable gas reinjection system according to the first embodiment is configured to be driven by the third liquid, suction a non-condensable gas contained in the first gas and remaining uncondensed in the evaporator, and discharge a fourth liquid in which the third liquid and the non-condensable gas are mixed. Further, in the non-condensable gas reinjection system according to the first embodiment, the first liquid and the fourth liquid are mixed and sent to the reinjection well. Further, in the non-condensable gas reinjection system according to the first embodiment, the third liquid is a condensate of the first gas condensed in the evaporator.

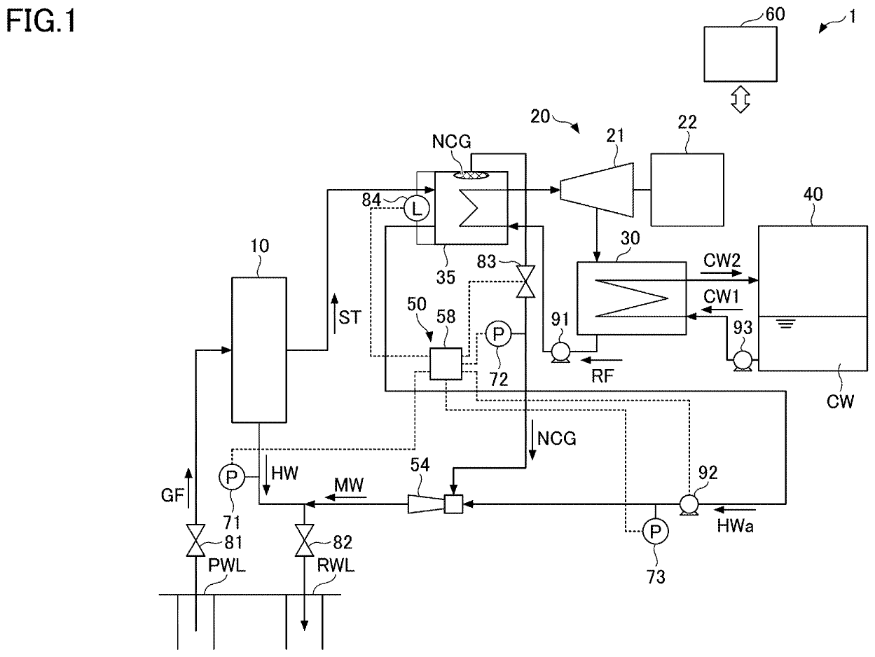

Next, the non-condensable gas reinjection system according to the first embodiment will be described in detail with reference to the drawings. FIG. 1 is a diagram schematically illustrating a configuration of a geothermal power plant 1 including a non-condensable gas reinjection system 50, which is an example of the non-condensable gas reinjection system according to the first embodiment.

The geothermal power plant 1 includes a gas-liquid separator 10, a power generation unit 20, a condenser 30, an evaporator 35, a cooling unit 40, the non-condensable gas reinjection system 50, and a control unit 60. The geothermal power plant 1 is a geothermal power plant using what is known as a binary geothermal power generation system. The geothermal power plant 1 further includes a valve 81, a valve 82, a pump 91, and a pump 93.

### Gas-Liquid Separator 10

The gas-liquid separator 10 separates geothermal fluid GF ejected from a production well PWL into steam ST and hot water HW. The valve 81 allows or blocks the flow of the geothermal fluid GF ejected from the production well PWL. The steam ST discharged from the gas-liquid separator 10 is sent to the evaporator 35. The hot water HW discharged from the gas-liquid separator 10 is discharged to a reinjection well RWL. A pressure gauge 71 described later measures the pressure of the hot water HW.

As used herein, the steam ST is not pure water vapor, and includes a gas, such as carbon dioxide or hydrogen sulfide, discharged from the production well PWL.

### Power Generation Unit 20

The power generation unit 20 generates power by using a working fluid RF heated by the steam ST to become a gas. The power generation unit 20 includes a turbine 21 and a power generator 22. The turbine 21 is rotated by the working fluid RF. More specifically, the turbine 21 is rotated by a pressure difference between the working fluid RF having changed from a liquid to a gas by heat exchange with the steam ST in the evaporator 35 and the working fluid RF having changed from a gas to a liquid by being cooled by cooling water CW1 in the condenser 30. The power generator 22 is connected to the turbine 21. Upon the turbine 21 being rotated, a rotating shaft of the power generator 22 is rotated to generate power. The power generated by the power generator 22 is supplied to the outside.

The working fluid RF is a fluid having a boiling point lower than water, and is, for example, ammonia, pentane, a CFC substitute, or the like. The working fluid RF is condensed from a gas into a liquid by being cooled in the condenser 30. Further, the working fluid RF is evaporated from a liquid to a gas by being heated in the evaporator 35. The working fluid RF is circulated in the order of the evaporator 35, the turbine 21, and the condenser 30 by the pump 91.

### Condenser 30

The condenser 30 cools the working fluid RF, discharged from the turbine 21, by using the cooling water CW1 supplied from the cooling unit 40. The working fluid RF is condensed from a gas into a liquid by being cooled in the condenser 30. The condenser 30 is, for example, a multi-tube heat exchanger, a plate heat exchanger, or the like.

### Evaporator 35

The evaporator 35 heats the working fluid RF by using the steam ST supplied from the gas-liquid separator 10. When the evaporator 35 heats the working fluid RF, the working fluid RF is evaporated and changed from a liquid to a gas. The evaporator 35 is, for example, a multi-tube heat exchanger or the like. The steam ST is cooled by heat exchange between the steam ST and the working fluid RF in the evaporator 35. When the steam ST is cooled, the steam ST is condensed into a condensate HWa.

A non-condensable gas NCG, such as carbon dioxide or hydrogen sulfide, contained in the steam ST accumulates in an upper portion of the evaporator 35. When the non-condensable gas NCG accumulates, the liquid level of the condensate Hwa of the steam ST condensed in the evaporator 35 decreases. When the liquid level of the condensate HWa of the steam ST condensed in the evaporator 35 decreases, heat exchange efficiency between the steam ST and the working fluid RF in the evaporator 35 decreases. Therefore, it is desirable to discharge the non-condensable gas NCG accumulated in the evaporator 35 from the evaporator 35.

In the geothermal power plant 1, the non-condensable gas NCG accumulated in the evaporator 35 is suctioned by the non-condensable gas reinjection system 50 and discharged to the reinjection well RWL.

The evaporator 35 is provided with a level meter 84. The level meter 84 measures the liquid level of the condensate HWa condensed in the evaporator 35. For example, when the non-condensable gas NCG accumulates in the evaporator 35, the liquid level measured by the level meter 84 decreases.

### Cooling Unit 40

The cooling unit 40 supplies cooling water CW to cool the working fluid RF in the condenser 30. The cooling unit 40 is, for example, a cooling tower. The cooling water CW1 cooled in the cooling unit 40 is sent to the condenser 30 by the pump 93. Cooling water CW2 whose temperature is increased through heat exchange with the steam ST in the condenser 30 returns to the cooling unit 40 and is cooled.

### Non-Condensable Gas Reinjection System 50

The non-condensable gas reinjection system 50 suctions the non-condensable gas NCG from the evaporator 35 and discharges the non-condensable gas NCG. The non-condensable gas reinjection system 50 includes an ejector 54, a controller 58, the pressure gauge 71, a pressure gauge 72, and a pressure gauge 73, a valve 83, and a pump 92. The ejector 54 is driven by the condensate HWa condensed in the evaporator 35. The condensate HWa is pumped by the pump 92. The ejector 54 discharges mixed water MW in which the non-condensable gas NCG and the condensate HWa are mixed.

The mixed water MW discharged from the ejector 54 is mixed with the hot water HW and sent to the reinjection well RWL. The valve 82 allows or blocks the flow of the mixed water MW and the hot water HW to be sent to the reinjection well RWL.

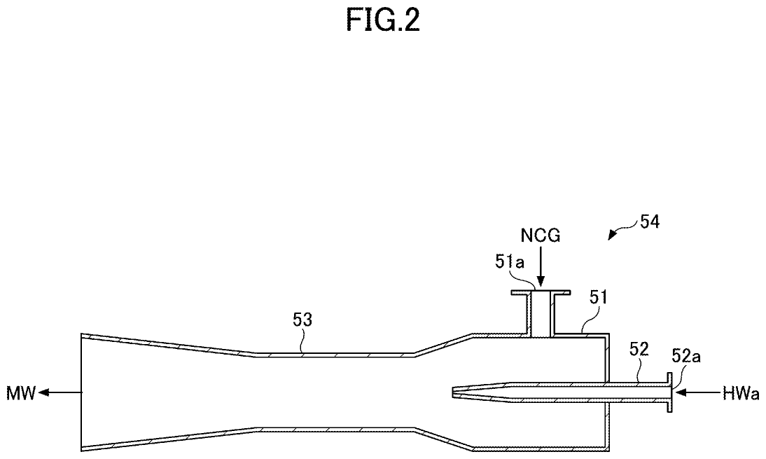

A structure of the ejector 54 will be described. FIG. 2 is a diagram schematically illustrating a configuration of the ejector 54 of the non-condensable gas reinjection system 50, which is the example of the non-condensable gas reinjection system according to the first embodiment.

The ejector 54 includes a suction part 51, a drive nozzle 52, and an expanded part 53. The suction part 51 includes a suction port 51a. The non-condensable gas NCG is suctioned through the suction port 51a. Further, the drive nozzle 52 is inserted into the suction part 51. The condensate HWa pressurized by the pump 92 is supplied to a drive port 52a of the drive nozzle 52. By discharging the high-velocity condensate HWa from the tip of the drive nozzle 52, the non-condensable gas NCG present in the suction part 51 is discharged while being mixed with the condensate Hwa. By discharging the non-condensable gas NCG, the ejector 54 suctions the non-condensable gas NCG.

The ejector 54 mixes the non-condensable gas NCG and the condensate HWa and discharges the mixed water MW through the expanded part 53.

The mixed water MW obtained by mixing the non-condensable gas NCG and the condensate HWa and discharged by the ejector 54 is mixed with the hot water HW and sent to the reinjection well RWL.

The ejector 54 is provided on the ground. By providing the ejector 54 on the ground, the maintenance of the ejector 54 can be facilitated.

The controller 58 is mainly configured with a computer including, for example, a processor, a storage device such as a memory, an auxiliary storage device, and an input/output interface device for communication with the outside. The processor is, for example, a central processing unit (CPU), a graphics processing unit (GPU), or a micro processing unit (MPU). The controller 58 may be, for example, a programmable logic controller (PLC).

In a case where the liquid level measured by the level meter 84 is decreased, the controller 58 determines that the non-condensable gas NCG is accumulated in the evaporator 35, opens the valve 83, operates the pump 92, and discharges the non-condensable gas NCG from the ejector 54.

Specifically, the level meter 84 measures the liquid level of the condensate Hwa of the steam ST condensed in the evaporator 35. Then, the controller 58 controls the opening and closing of the valve 83 based on the liquid level measured by the level meter 84. More specifically, in a case where the liquid level of the condensate HWa in the evaporator 35 measured by the level meter 84 becomes lower than a predetermined liquid level, the controller 58 opens the valve 83 and starts the pump 92. By opening the valve 83 and starting the pump 92, the non-condensable gas NCG is discharged from the evaporator 35 by the ejector 54. Further, in a case where the liquid level of the condensate HWa in the evaporator 35 measured by the level meter 84 becomes higher than the predetermined liquid level, the controller 58 closes the valve 83 and stops the pump 92. By closing the valve 83 and stopping the pump 92, the discharge of the non-condensable gas NCG from the evaporator 35 is stopped.

In a case where a pressure P1 at the pressure gauge 71 becomes higher than a pressure P2 at the pressure gauge 73 while power is generated, the controller 58 performs control such that the valve 83 is closed, thereby preventing the hot water HW from flowing into the evaporator 35. The valve 83 is provided in a flow passage through which the non-condensable gas NCG flows between the evaporator 35 and the ejector 54. Note that the pressure P1 at the pressure gauge 71 is the pressure of the hot water HW, and the pressure P2 at the pressure gauge 73 is the discharge pressure of the pump 92.

Further, the controller 58 may use the pressure gauge 72 to monitor the pressure of the non-condensable gas NCG.

### Control Unit 60

The control unit 60 controls the entire geothermal power plant 1. The control unit 60 is mainly configured with a computer including, for example, a processor, a storage device such as a memory, an auxiliary storage device, and an input/output interface device for communication with the outside. The processor is, for example, a CPU, a GPU, or an MPU. The control unit 60 may be, for example, a programmable logic controller.

The control unit 60 controls each of the pump 91 and the pump 93. The control unit 60 controls each of the pump 91 and the pump 93 to start when power is generated. The control unit 60 controls each of the pump 91 and the pump 93 to stop when power generation is stopped.

In geothermal power generation, carbon dioxide is mainly discharged as a non-condensable gas although the amount of carbon dioxide is much smaller than that in thermal power generation. For example, 90% of the non-condensable gas contained in geothermal fluid discharged from a production well is carbon dioxide. In countries outside of Japan, for example, in New Zealand, carbon taxes are already incurred on carbon dioxide discharged in geothermal power generation. Similarly, in Japan, there is a possibility that the cost of geothermal power generation may increase due to carbon dioxide contained in the non-condensable gas.

In the non-condensable gas reinjection system according to the first embodiment, the amount of the non-condensable gas, such as carbon dioxide, discharged during geothermal power generation to the atmosphere can be reduced by returning the non-condensable gas to the reinjection well.

Further, in the non-condensable gas reinjection system according to the first embodiment, by using the ejector that is driven by the condensate of the first gas condensed in the evaporator and that suctions the non-condensable gas, for example, environmental impacts such as the toxicity of hydrogen sulfide contained in the non-condensable gas to the human body and the contamination of surrounding plants and soil can be reduced.

Note that the pressure gauge 71 is an example of a first pressure gauge, the pressure gauge 73 is an example of a second pressure gauge, and the level meter 84 is an example of a second level meter.

### Second Embodiment

A non-condensable gas reinjection system according to a second embodiment will be described. In the non-condensable gas reinjection system according to the first embodiment, the third liquid is the condensate of the first gas condensed in the evaporator, whereas in the non-condensable gas reinjection system according to the second embodiment, the third liquid is a portion of cooling water sent to a condenser.

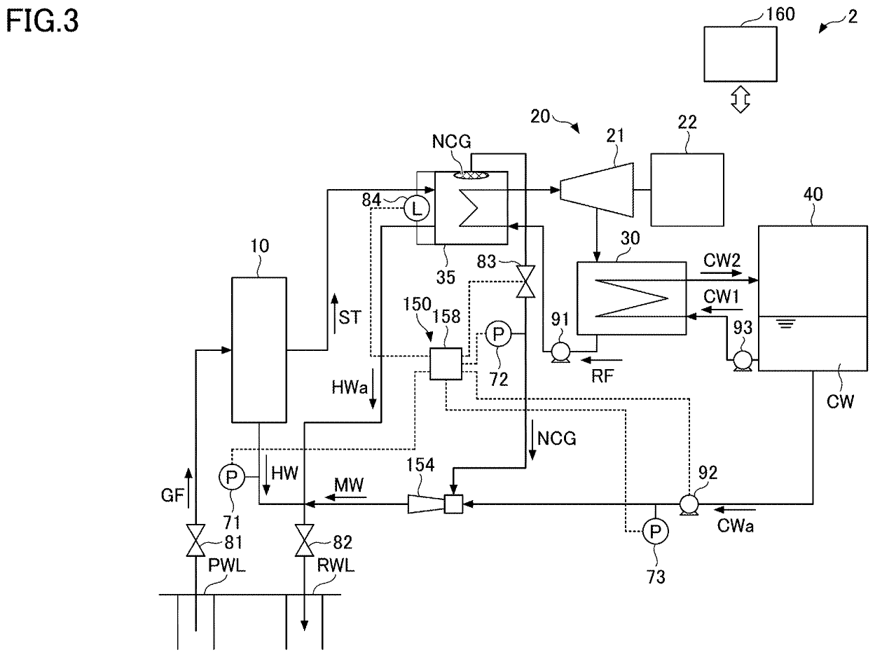

Next, the non-condensable gas reinjection system according to the second embodiment will be described in detail with reference to the drawings. FIG. 3 is a diagram schematically illustrating a configuration of a geothermal power plant 2 including a non-condensable gas reinjection system 150, which is an example of the non-condensable gas reinjection system according to the second embodiment.

The geothermal power plant 2 includes a gas-liquid separator 10, a power generation unit 20, a condenser 30, an evaporator 35, a cooling unit 40, the non-condensable gas reinjection system 150, and a control unit 160. The geothermal power plant 2 further includes a valve 81, a valve 82, a pump 91, and a pump 93. The control unit 160 has the same functions as the control unit 60.

For a configuration of the geothermal power plant 2 common to that of the geothermal power plant 1, the description of the geothermal power plant 1 is referred to and a detailed description thereof will be omitted.

The non-condensable gas reinjection system 150 pressurizes cooling water CWa, which is a portion of cooling water CW, by a pump 92 and supplies the cooling water CWa to an ejector 154. The non-condensable gas reinjection system 150 includes the ejector 154, a controller 158, a pressure gauge 71, a pressure gauge 72, and a pressure gauge 73, a valve 83, and the pump 92. The ejector 154 has the same configuration as the ejector 54. The controller 158 has the same functions and configuration as the controller 58.

The ejector 154 is driven by the cooling water CWa, which is a portion of the cooling water CW. The cooling water CWa is pumped by the pump 92. The ejector 154 discharges mixed water MW in which a non-condensable gas NCG and the cooling water CWa are mixed.

The ejector 154 mixes the non-condensable gas NCG and the cooling water CWa and discharges the mixed water MW. The mixed water MW obtained by mixing the non-condensable gas NCG and the cooling water CWa and discharged by the ejector 154 is mixed with hot water HW and a condensate HWa and sent to a reinjection well RWL.

Similar to the non-condensable gas reinjection system according to the first embodiment, in the non-condensable gas reinjection system according to the second embodiment, the amount of the non-condensable gas, such as carbon dioxide, discharged into the atmosphere in geothermal power generation can be reduced by returning the non-condensable gas to the reinjection well.

### Third Embodiment

A non-condensable gas reinjection system according to a third embodiment will be described. In the non-condensable gas reinjection system according to the first embodiment, the third liquid is the condensate of the first gas condensed in the evaporator, whereas in the non-condensable gas reinjection system according to the third embodiment, the third liquid is a portion of the first liquid.

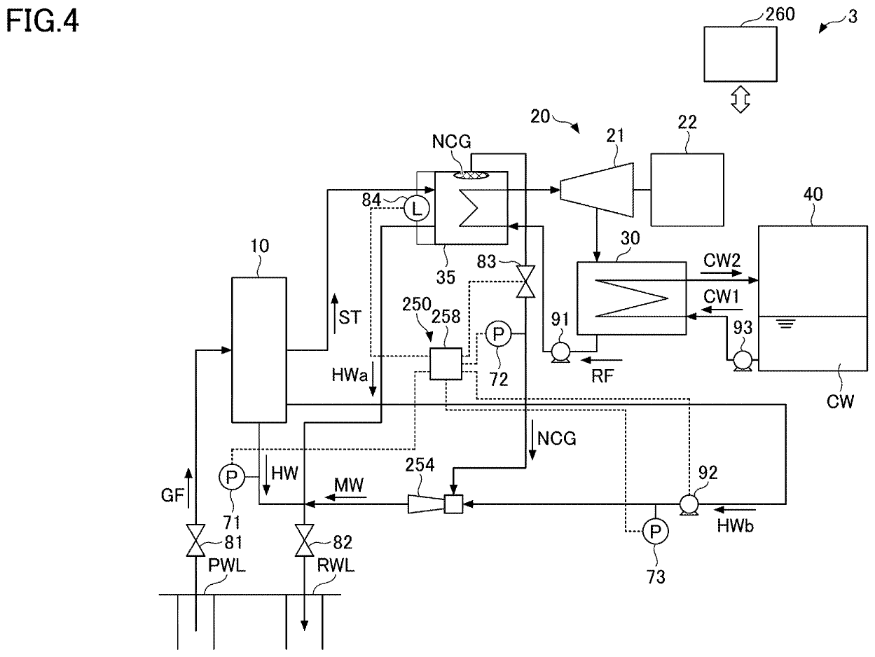

Next, the non-condensable gas reinjection system according to the third embodiment will be described in detail with reference to the drawings. FIG. 4 is a diagram schematically illustrating a configuration of a geothermal power plant 3 including a non-condensable gas reinjection system 250, which is an example of the non-condensable gas reinjection system according to the third embodiment.

The geothermal power plant 3 includes a gas-liquid separator 10, a power generation unit 20, a condenser 30, an evaporator 35, a cooling unit 40, the non-condensable gas reinjection system 250, and a control unit 260. The geothermal power plant 3 further includes a valve 81, a valve 82, a pump 91, and a pump 93. The control unit 260 has the same functions as the control unit 60.

For a configuration of the geothermal power plant 3 common to that of the geothermal power plant 1, the description of the geothermal power plant 1 is referred to and a detailed description thereof will be omitted.

The non-condensable gas reinjection system 250 pressurizes hot water HWb, which is a portion of hot water HW discharged from the gas-liquid separator 10, by a pump 92 and supplies the hot water HWb to an ejector 254. The non-condensable gas reinjection system 250 includes the ejector 254, a controller 258, a pressure gauge 71, a pressure gauge 72, and a pressure gauge 73, a valve 83, and the pump 92. The ejector 254 has the same configuration as the ejector 54. The controller 258 has the same functions and configuration as the controller 58.

The ejector 254 is driven by the hot water HWb, which is a portion of the hot water HW discharged from the gas-liquid separator 10. The hot water HWb is pumped by the pump 92. The ejector 254 discharges mixed water MW in which a non-condensable gas NCG and the hot water HWb are mixed.

The ejector 254 mixes the non-condensable gas NCG and the hot water HWb and discharges the mixed water MW. The mixed water MW obtained by mixing the non-condensable gas NCG and the hot water HWb and discharged by the ejector 254 is mixed with the hot water HW and a condensate HWa and sent to a reinjection well RWL.

Similar to the non-condensable gas reinjection system according to the first embodiment, in the non-condensable gas reinjection system according to the third embodiment, the amount of the non-condensable gas, such as carbon dioxide, discharged into the atmosphere in geothermal power generation can be reduced by returning the non-condensable gas to the reinjection well.

### fourth Embodiment

A non-condensable gas reinjection system according to a fourth embodiment will be described. A geothermal power plant including the non-condensable gas reinjection system according to the fourth embodiment further includes a reinjection pit configured to store the first liquid. In the non-condensable gas reinjection system according to the first embodiment, the third liquid is the condensate of the first gas condensed in the evaporator, whereas in the non-condensable gas reinjection system according to the fourth embodiment, the third liquid is a portion of the first liquid stored in the reinjection pit.

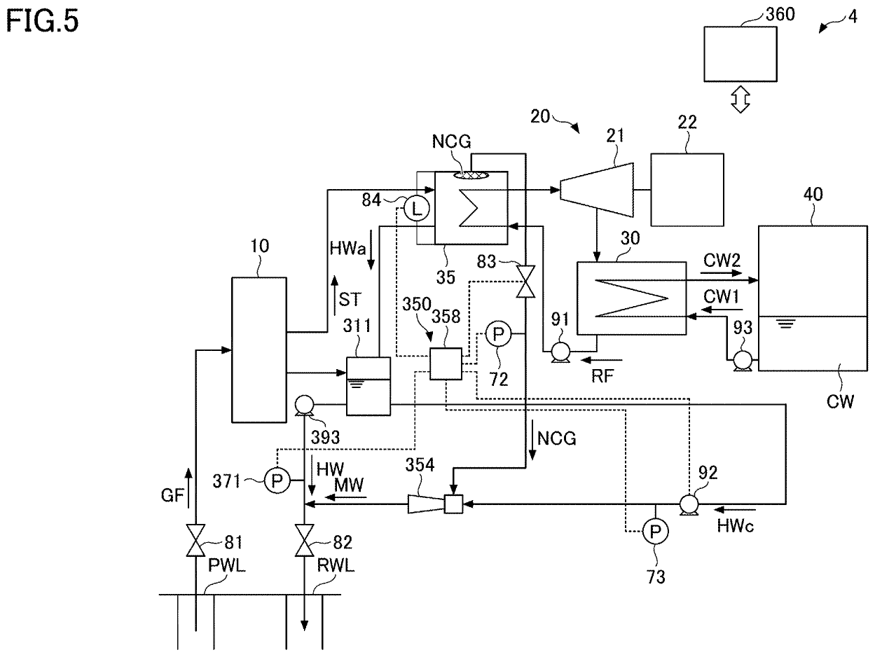

Next, the non-condensable gas reinjection system according to the fourth embodiment will be described in detail with reference to the drawings. FIG. 5 is a diagram schematically illustrating a configuration of a geothermal power plant 4 including a non-condensable gas reinjection system 350, which is an example of the non-condensable gas reinjection system according to the fourth embodiment.

The geothermal power plant 4 includes a gas-liquid separator 10, a power generation unit 20, a condenser 30, an evaporator 35, a cooling unit 40, the non-condensable gas reinjection system 350, and a control unit 360. The geothermal power plant 4 further includes a valve 81, a valve 82, a pump 91, and a pump 93. The geothermal power plant 4 further includes a reinjection pit 311 and a pump 393. The control unit 360 has the same functions as the control unit 60.

For a configuration of the geothermal power plant 4 common to that of the geothermal power plant 1, the description of the geothermal power plant 1 is referred to and a detailed description thereof will be omitted.

The geothermal power plant 4 includes the reinjection pit 311 configured to store hot water HW discharged from the gas-liquid separator 10. The hot water HW stored in the reinjection pit 311 is sent to a reinjection well RWL by the pump 393. Further, hot water HWc, which is a portion of the hot water HW stored in the reinjection pit 311, is pressurized by a pump 92 and supplied to an ejector 354. The reinjection pit 311 may be a tank or a pool.

The ejector 354 mixes a non-condensable gas NCG and the hot water HWc and discharges mixed water MW. The mixed water MW obtained by mixing the non-condensable gas NCG and the hot water HWc and discharged by the ejector 354 is mixed with the hot water HW and sent to the reinjection well RWL.

The non-condensable gas reinjection system 350 pressurizes the hot water HWc, which is a portion of the hot water HW stored in the reinjection pit 311, by the pump 92 and supplies the hot water HWc to the ejector 354. The non-condensable gas reinjection system 350 includes the ejector 354, a controller 358, a pressure gauge 371, a pressure gauge 72, a pressure gauge 73, a valve 83, and the pump 92. Instead of the pressure gauge 71 of the non-condensable gas reinjection system 50, the non-condensable gas reinjection system 350 includes the pressure gauge 371 and measures a pressure P1 of the hot water HW by using the pressure gauge 371. The ejector 354 has the same configuration as the ejector 54. The controller 358 has the same functions and configuration as the controller 58.

The ejector 354 is driven by the hot water HWc, which is a portion of the hot water HW stored in the reinjection pit 311. The hot water HWc is pumped by the pump 92. The ejector 354 discharges the mixed water MW in which the non-condensable gas NCG and the hot water HWc are mixed.

The ejector 354 mixes the non-condensable gas NCG and the hot water HWc and discharges the mixed water MW. The mixed water MW obtained by mixing the non-condensable gas NCG and the hot water HWc and discharged by the ejector 354 is mixed with the hot water HW and sent to the reinjection well RWL.

Similar to the non-condensable gas reinjection system according to the first embodiment, in the non-condensable gas reinjection system according to the fourth embodiment, the amount of the non-condensable gas, such as carbon dioxide, discharged into the atmosphere in geothermal power generation can be reduced by returning the non-condensable gas to the reinjection well.

### Determination As To Whether Non-Condensable Gas is Dissolved in Non-Condensable Gas Reinjection System According to Embodiment of Present Disclosure

A determination as to whether a non-condensable gas is dissolved in mixed water discharged from an ejector in a non-condensable gas reinjection system according to an embodiment of the present disclosure will be described. It is desirable that the non-condensable gas is completely dissolved in the third liquid in the mixed water discharged from the ejector. In the following, a method of determining whether the non-condensable gas is dissolved in the third liquid will be described.

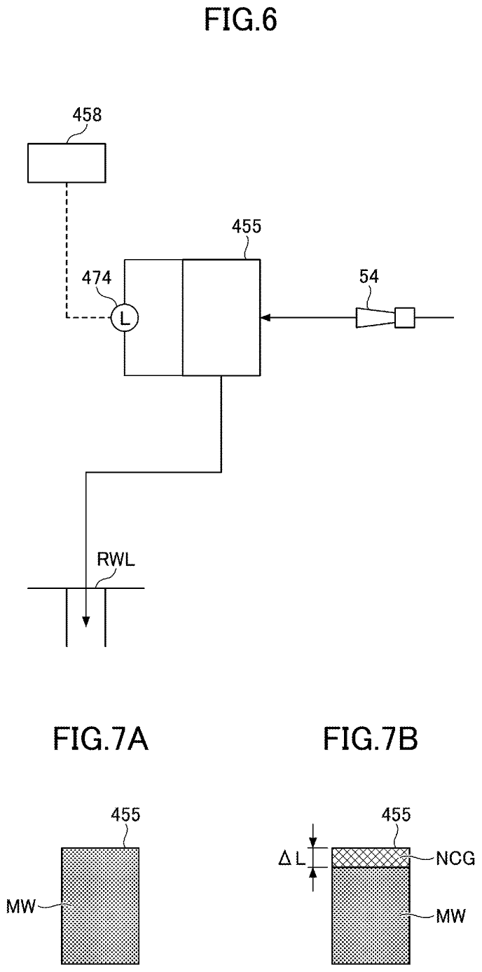

FIG. 6 and FIGS. 7A and 7B are diagrams each illustrating a determination as to whether the non-condensable gas is dissolved in the non-condensable gas reinjection system according to the embodiment of the present disclosure. In the following description, the ejector 54 is used. Instead of the ejector 54, any one of the ejector 154, the ejector 254 and the ejector 354 can be used.

A tank 455 is provided downstream of the ejector 54. The tank 455 is provided with a level meter 474. The level meter 474 measures the level of a liquid stored in the tank 455. The measured result is output to a controller 458. The controller 458 determines whether a non-condensable gas NCG is dissolved.

As illustrated in FIG. 7A, in a case where the non-condensable gas NCG is completely dissolved in mixed water MW, the interior of the tank 455 is filled with the mixed water MW. Conversely, as illustrated in FIG. 7B, in a case where the non-condensable gas NCG is not completely dissolved in the mixed water MW, the non-condensable gas NCG accumulates in an upper portion of the tank. Therefore, in a case where the non-condensable gas NCG accumulates, the level measured by the level meter 474 decreases by a level ΔL. Therefore, it is possible to determine whether the non-condensable gas NCG is dissolved in the mixed water MW by using the level meter 474 to measure the level of the mixed water MW in the tank 455.

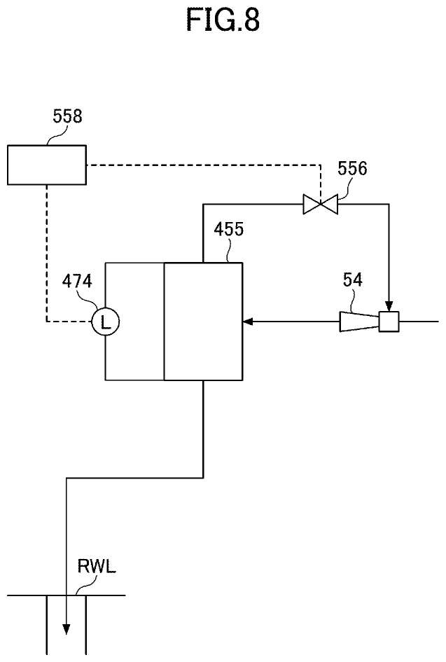

Here, processing in a case where the non-condensable gas NCG is not dissolved will be described. FIG. 8 is a diagram illustrating a first example of processing in a case where the non-condensable gas is not dissolved in the non-condensable gas reinjection system according to the embodiment of the present disclosure. If a controller 558 determines that the non-condensable gas NCG is not dissolved based on the level measured by the level meter 474, the controller 558 opens a valve 556 provided in a pipe connecting the tank 455 and the ejector 54. By opening the valve 556, the non-condensable gas NCG is suctioned from the ejector 54.

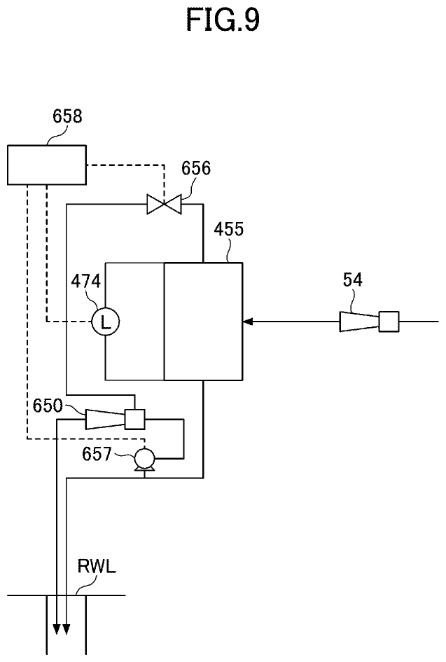

Further, another example will be described. FIG. 9 is a diagram illustrating a second example of processing in a case where the non-condensable gas is not dissolved in the non-condensable gas reinjection system according to the embodiment of the present disclosure. In the second example, an additional ejector 650 is further included. In addition, a pump 657 configured to supply a pressurized drive fluid to the ejector 650 is included. The non-condensable gas NCG accumulated in the tank 455 is discharged from the ejector 650 other than the ejector 54. In a case where a controller 658 determines that the non-condensable gas NCG is not dissolved based on the level measured by the level meter 474, the controller 658 opens a valve 656, starts the pump 657, and uses the ejector 650 to suction the non-condensable gas NCG in the tank 455. The ejector 650 discharges mixed water MW in which the non-condensable gas NCG is mixed to the reinjection well RWL.

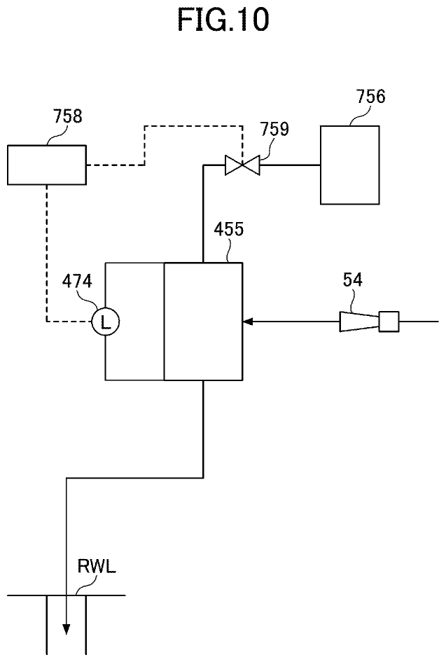

Further, yet another example will be described. FIG. 10 is a diagram illustrating a third example of processing in a case where the non-condensable gas is not dissolved in the non-condensable gas reinjection system according to the embodiment of the present disclosure. In the third example, a tank 756 configured to store a chemical agent is included. The chemical agent is, for example, an alkali agent. In a case where a controller 758 determines that the non-condensable gas NCG is not dissolved based on the level measured by the level meter 474, the controller 758 opens a valve 759 between the tank 455 and the tank 756 and injects the chemical agent into the tank 455. The chemical agent is sprayed or introduced from the upper part of the tank 455.

In each of the non-condensable gas reinjection systems according to the first embodiment to the fourth embodiment, the above-described examples may be appropriately combined.

The controller 458, the controller 558, the controller 658, and the controller 758 have the same functions as the controller included in each of the non-condensable gas reinjection systems according to the first embodiment to the fourth embodiment.

Note that the level meter 474 is an example of a first level meter.

### Fifth Embodiment

A non-condensable gas reinjection system according to a fifth embodiment will be described. The non-condensable gas reinjection system according to the fifth embodiment differs from the non-condensable gas reinjection system according to the first embodiment in that a plurality of ejectors are included.

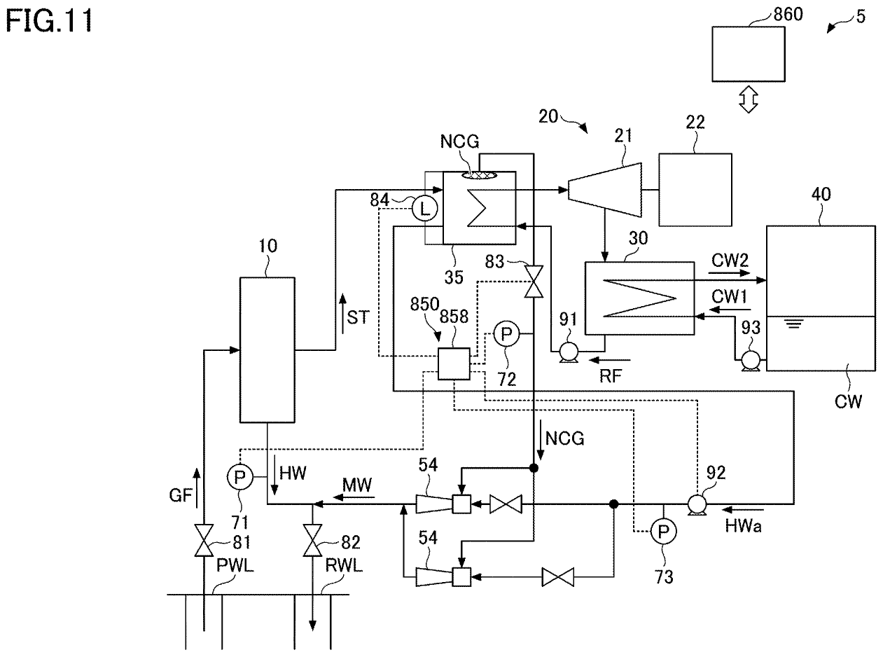

Next, the non-condensable gas reinjection system according to the fifth embodiment will be described in detail with reference to the drawings. FIG. 11 is a diagram schematically illustrating a configuration of a geothermal power plant 5 including a non-condensable gas reinjection system 850, which is an example of the non-condensable gas reinjection system according to the fifth embodiment.

The geothermal power plant 5 includes a gas-liquid separator 10, a power generation unit 20, a condenser 30, an evaporator 35, a cooling unit 40, the non-condensable gas reinjection system 850, and a control unit 860. The geothermal power plant 5 further includes a valve 81, a valve 82, a pump 91, and a pump 93.

For a configuration of the geothermal power plant 5 common to that of the geothermal power plant 1, the description of the geothermal power plant 1 is referred to and a detailed description thereof will be omitted.

The non-condensable gas reinjection system 850 includes a plurality of ejectors 54, a controller 858, a pressure gauge 71, a pressure gauge 72, a pressure gauge 73, a valve 83, and a pump 92. By including the plurality of ejectors 54, the non-condensable gas reinjection system 850 includes a plurality of lines including the ejectors 54 in parallel. Because the non-condensable gas reinjection system 850 includes the plurality of lines including the ejectors 54 in parallel, the maintenance of the ejectors 54 can be performed without stopping the entire non-condensable gas reinjection system 850 by operating some of the lines.

Similar to the non-condensable gas reinjection system according to the first embodiment, in the non-condensable gas reinjection system according to the fifth embodiment, the amount of the non-condensable gas, such as carbon dioxide, discharged into the atmosphere in geothermal power generation can be reduced by returning the non-condensable gas to the reinjection well. Further, because the non-condensable gas reinjection system according to the fifth embodiment includes the plurality of ejectors, the maintainability can be improved by switching between the ejectors.

In the example of FIG. 11, the geothermal power plant 5 having the same configuration as the geothermal power plant 1 including the non-condensable gas reinjection system 50, which is the example of the non-condensable gas reinjection system according to the first embodiment, has been described as an example. However, the configuration of the geothermal power plant 5 is not limited to that of the geothermal power plant 1 including the non-condensable gas reinjection system 50 according to the first embodiment. Any of the geothermal power plants including the non-condensable gas reinjection systems according to the second embodiment to the fourth embodiment may similarly include a plurality of lines including ejectors. Further, in the non-condensable gas reinjection system according to the fifth embodiment, the above-described processing in a case where the non-condensable gas is not dissolved may be performed.

The embodiments disclosed herein are exemplary in all respects and are not intended to be restrictive. The above-described embodiments may be omitted, substituted, or modified in various forms without departing from the scope and spirit of the appended claims.

The present disclosure provides a non-condensable gas reinjection system that returns a non-condensable gas contained in geothermal fluid to a reinjection well and has high maintainability.

What is claimed is:

1. A non-condensable gas reinjection system for use in a geothermal power plant, the geothermal power plant including a gas-liquid separator configured to separate geothermal fluid obtained from a production well into a first gas and a first liquid, an evaporator configured to exchange heat between the first gas and a working fluid, a turbine configured to be rotated by the working fluid discharged from the evaporator, and a condenser configured to cool the working fluid that has rotated the turbine and to condense the working fluid into a liquid, the non-condensable gas reinjection system comprising:
a pump configured to pressurize a third liquid to be sent to a reinjection well; and
an ejector configured to be driven by the third liquid, to suction a non-condensable gas contained in the first gas and remaining uncondensed in the evaporator, and to discharge a fourth liquid in which the third liquid and the non-condensable gas are mixed, wherein
the first liquid and the fourth liquid are mixed and sent to the reinjection well.

2. The non-condensable gas reinjection system according to claim 1, wherein the third liquid is a condensate of the first gas condensed in the evaporator.

3. The non-condensable gas reinjection system according to claim 1, wherein the third liquid is a portion of cooling water sent to the condenser.

4. The non-condensable gas reinjection system according to claim 1, wherein the third liquid is a portion of the first liquid.

5. The non-condensable gas reinjection system according to claim 1, wherein
the geothermal power plant further includes a reinjection pit configured to store the first liquid, and
the third liquid is a portion of the first liquid stored in the reinjection pit.

6. The non-condensable gas reinjection system according to claim 1, wherein the ejector is provided on ground.

7. The non-condensable gas reinjection system according to claim 1, further comprising:
a tank configured to be connected downstream of the ejector;
a first level meter configured to measure a level of a liquid stored in the tank; and
a controller, wherein
the controller determines whether the non-condensable gas is dissolved in the fourth liquid based on the level measured by the first level meter.

8. The non-condensable gas reinjection system according to claim 7, wherein, in response to determining that the non-condensable gas is not dissolved in the fourth liquid, the controller performs control such that the non-condensable gas accumulated in the tank is discharged from the ejector.

9. The non-condensable gas reinjection system according to claim 7, wherein, in response to determining that the non-condensable gas is not dissolved in the fourth liquid, the controller performs control such that the non-condensable gas accumulated in the tank is discharged to the reinjection well from another ejector other than the ejector.

10. The non-condensable gas reinjection system according to claim 7, wherein, in response to determining that the non-condensable gas is not dissolved in the fourth liquid, the controller performs control such that a chemical agent is injected into the tank.

11. The non-condensable gas reinjection system according to claim 1, further comprising:
a first pressure gauge configured to measure a pressure of the first liquid;
a second pressure gauge configured to measure a pressure of the third liquid;
a valve provided in a flow passage between the evaporator and the ejector; and
a controller, wherein
the controller shuts off the valve in a case where the pressure of the first liquid measured by the first pressure gauge is higher than the pressure of the third liquid measured by the second pressure gauge.

12. The non-condensable gas reinjection system according to claim 1, further comprising:
a second level meter configured to measure a liquid level of a condensate of the first gas condensed in the evaporator;
a valve provided in a flow passage between the evaporator and the ejector; and
a controller, wherein
the controller controls opening and closing of the valve based on the level measured by the second level meter.
